(19) United States
(12) Patent Application Publication
(10) Pub. No.: US 2016/0021153 A1
(43) Pub. Date: Jan. 21, 2016

(54) SYSTEM AND COMPUTER PROGRAM FOR SOCIAL MEDIA UTILIZING NAVIGATION

(71) Applicant: Highway Hottie, LLC, Media, PA (US)

(72) Inventors: Wesley Francis Hull, Media, PA (US); Katrina Lynn Bonetsky, Claymont, DE (US); Jeremy Matthew Gaffney, Mesa, AZ (US); Mahesh Chand, Garnet Valley, PA (US); Elizabeth Ann Capozzoli, Glen Mills, PA (US); Lauren Marie Alexanderson, Philadelphia, PA (US)

(73) Assignee: Highway Hottie, LLC, Media, PA (US)

(21) Appl. No.: 14/460,062

(22) Filed: Aug. 14, 2014

Related U.S. Application Data
(60) Provisional application No. 62/025,087, filed on Jul. 16, 2014.

(51) Int. Cl. H04L 29/06; G06F 3/0484; G06F 3/0482; G06F 17/30; G06F 3/0481

(52) U.S. Cl. CPC H04L 65/403; G06F 17/30241; G06F 3/04817; G06F 3/0482; G06F 3/04842

(57) ABSTRACT

A system, computer program, and method for location-based social media interaction between a plurality of participants. The system may receive and store user profiles for participating users and associate two or more participating users with each other allowing sharing of user profile and location information. The system may receive geographic coordinates of the participating users and send map information to participant devices of the participating users. The map information may be used to display icons on a map on the participant devices illustrating geographic locations of some or all of the participating users. The system may also receive a selection of one of the icons on the map from a first participant device and provide directions to a second participant device associated with the selected one of the icons on the map, or directions to a waypoint between the first and second participant devices.

### RELATED APPLICATIONS

This application claims priority benefit of a provisional application entitled, “System and Computer Program for Social Media Utilizing Navigation,” Ser. No. 62/025,087, filed Jul. 16, 2014 and incorporated by reference herein in its entirety.

### BACKGROUND

Social media networks, such as FACEBOOK, allow individuals to communicate with each other remotely and post content of interest to be viewed by other individuals of their choosing. This content may include a location of the person posting a picture, article, or status update, however that person's location is only shown at the time of posting. Furthermore, if a person wants to meet up with a fellow user of the social media network based on a location listed in their most-recent post, this person would need to manually enter or copy and paste the listed location into a separate navigation application. Furthermore, if the location is within a large area, such as a park or a sports stadium, the persons may not be able to locate each other without calling, messaging, or otherwise coordinating a specific location or landmark at which to meet.

### SUMMARY OF THE INVENTION

Embodiments of the present invention solve the above-mentioned problems and provide a distinct advance in the art of systems and computer programs for coordinating navigation with social media. Specifically, embodiments of the present invention may provide systems, methods, and computer programs that manage a plurality of profiles for users, including real-time geographic locations of the users.

One embodiment of the invention provides a system for location-based social media interaction between a plurality of participants. The system may include a server device having a processing element and associated memory element. The processing element may execute a server application stored in the memory element. The server application may include code segments for receiving a plurality of user profiles for a plurality of participating users and associating two or more of the participating users with each other. The participant devices of the participating users associated with each other may access at least some information from each other's user profiles. The server application may also include code segments for receiving geographic coordinates corresponding to geographic locations of the participating users from geolocation devices of the participant devices and sending map information to participant devices. The map information may be used to display icons on a map on the participant devices illustrating geographic locations of a plurality of the participating users.

Another embodiment of the invention provides a non-transitory computer-readable storage medium with an executable program stored thereon for location-based social media interaction between a plurality of participants. The program may include the code segments described above and may additionally include a code segment for receiving a selection of one of the icons on the map from a first one of the participant devices of a first one of the participating users. The selected one of the icons may correspond with a second one of the participating users having a second one of the participant devices. Furthermore, the program may include a code segment for sending to the first one of the participant devices route directions for traveling from the first one of the participant devices to the second one of the participant devices or to a waypoint between the first one and the second one of the participant devices.

According to another embodiment of the invention, a computer-implemented method for location-based social media interaction may include the steps of receiving a plurality of user profiles for a plurality of participating users and associating two or more of the participating users with each other. The participant devices of the participating users associated with each other may access at least some information from each other's' user profiles. The method may also include receiving geographic coordinates corresponding to geographic locations of the participating users from geolocation devices of the participant devices and sending map information to the participant devices. The map information may be used to display icons on a map on the participant devices illustrating geographic locations of a plurality of the participating users. The method may further include the step of receiving a selection of one of the icons on the map from a first one of the participant devices of a first one of the participating users. The selected one of the icons may correspond with a second one of the participating users having a second one of the participant devices. Furthermore, the method may include the steps of determining, automatically with the server, a location of a waypoint between the first participant device and the second participant device, then sending to the first one of the participant devices turn-by-turn directions for the route for traveling between the first and second participant devices or turn-by-turn directions to the waypoint. The location of the waypoint may be equidistance between the first and second participant devices, a point along a route for traveling between the first and second participant devices that provides equal traveling time for the first and second participating users, and/or at a type of geographic location selected by the first or second participating users and closest to a mid-way point along the route between the first and second participant devices.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic block diagram of a system for operating a location and navigation-based social media computer program, constructed in accordance with various embodiments of the present invention;

FIG. 2 is a schematic block diagram of the components of a server device;

FIG. 3 is a block diagram depicting a plurality of participant devices;

FIG. 4 is a schematic block diagram of the components of a participant device;

FIG. 5 is a flow diagram of at least a portion of the steps of a method for operating a location and navigation-based social media computer program; and

FIG. 6 is a screen shot of a news feed associated with a user profile displayed on one of the participant devices of FIG. 3;

FIG. 7 is a screen shot of a page displaying vehicle information associated with the user profile of FIG. 6;

FIG. 8 is a screen shot of a map displayed on one of the participant devices of FIG. 3, illustrating icons associated with locations of a plurality of participant devices;

FIG. 9 is a screen shot of the map of FIG. 8 with one of the icons selected to display additional information; and

FIG. 10 is a screen shot of the map of FIG. 8 with a search dialogue box and touch screen keyboard to search for specific participating users.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

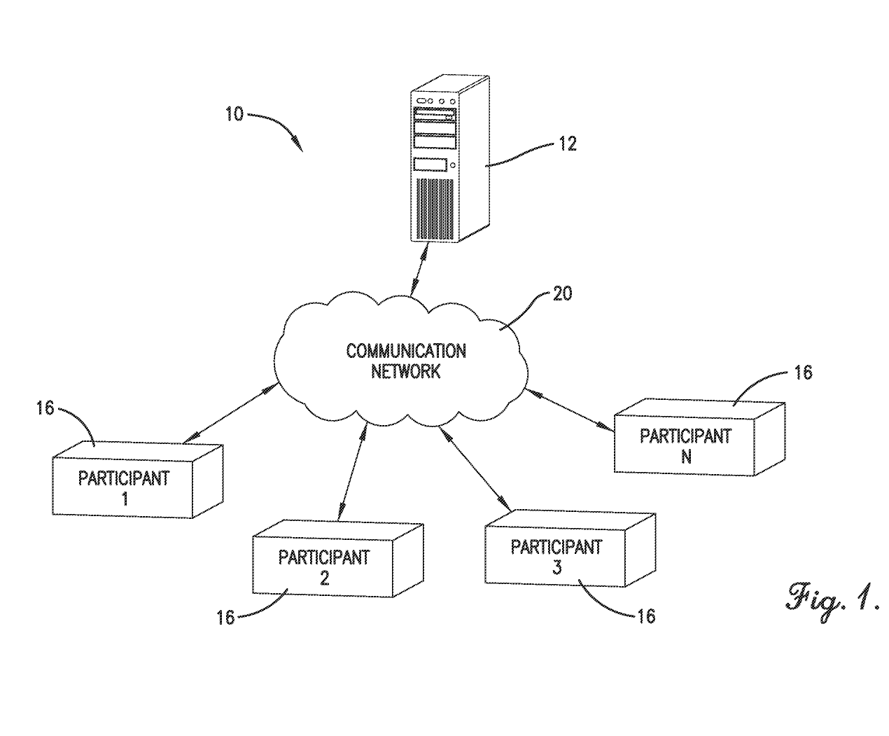

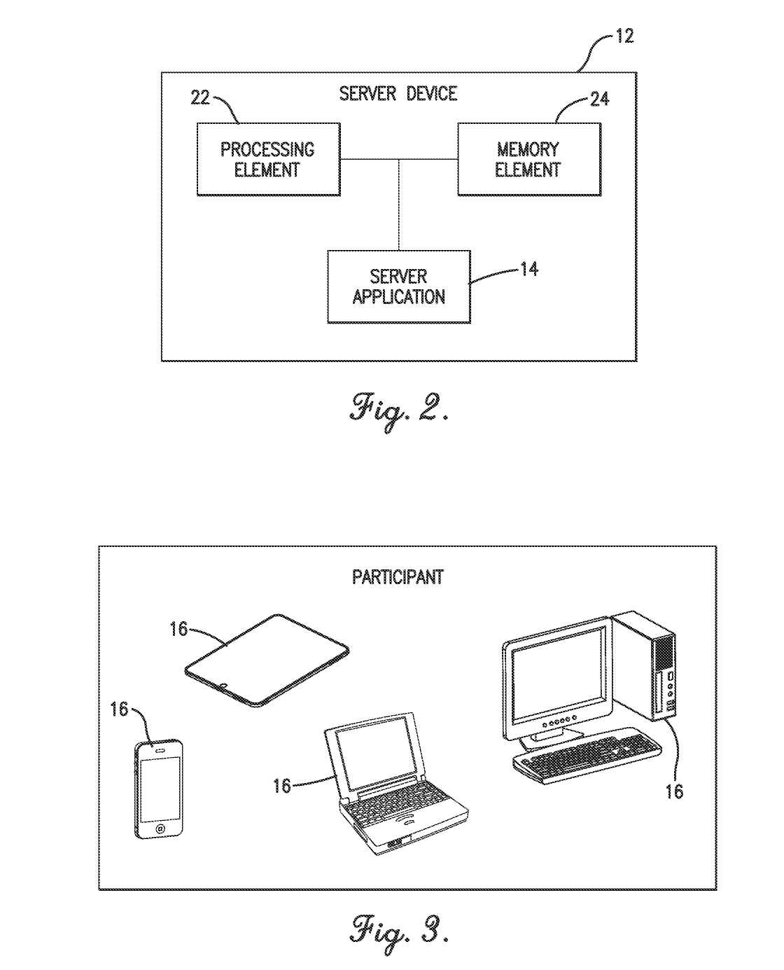

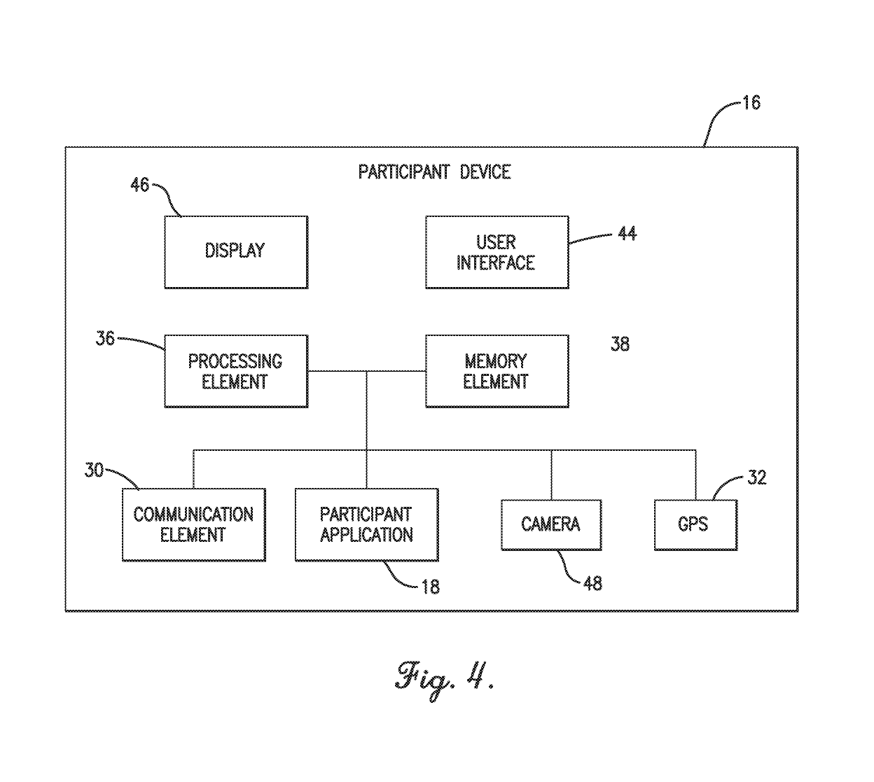

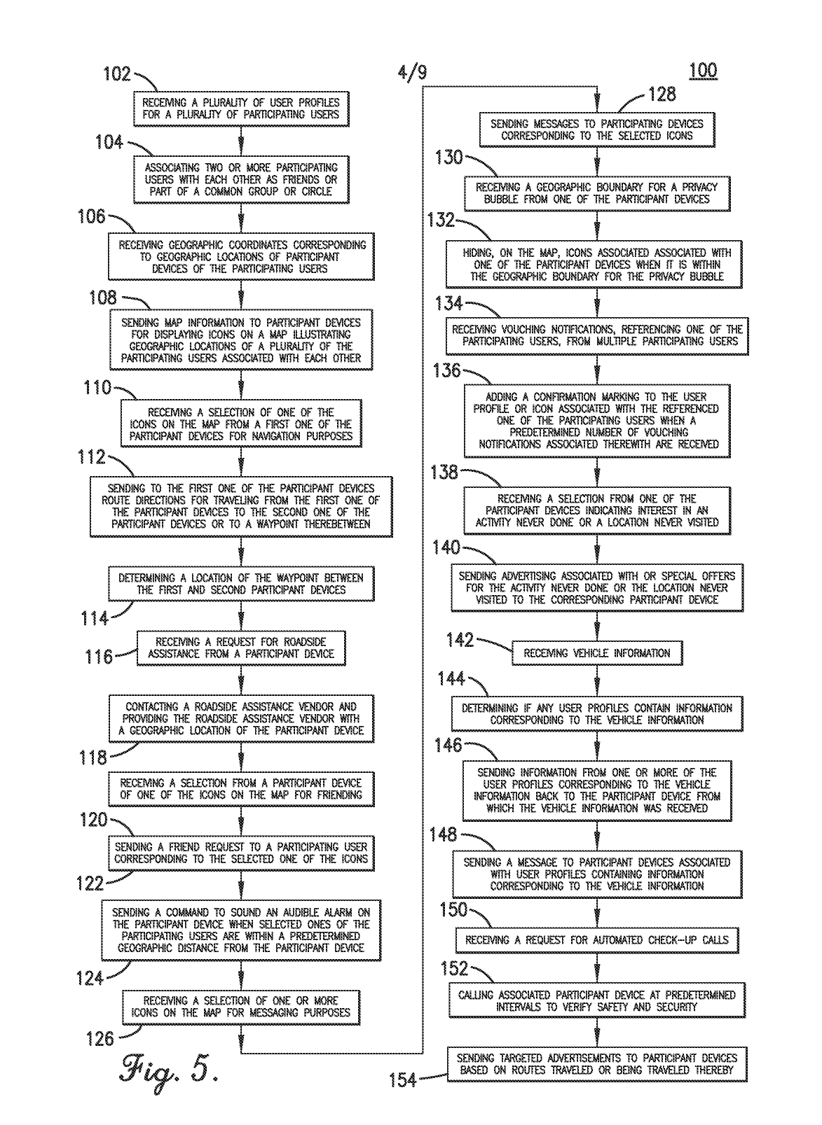

A system 10 for operating a location-based social media computer program, constructed in accordance with various embodiments of the current invention, is shown in FIG. 1. The social media computer program is configured to facilitate communication between a plurality of users each having a unique user profile. The system 10 may broadly comprise a server device 12 having a server application 14, as illustrated in FIG. 2. Furthermore, the system 10 may communicate with a plurality of participant devices 16, as illustrated in FIGS. 1 and 3, each executing associated participant applications 18, as illustrated in FIG. 4. Communication with the participant devices 16 may occur through a communication network 20. Various embodiments of the current invention may be implemented in hardware, software, firmware, or combinations thereof.

As illustrated in FIG. 2, the server device 12 generally stores electronic data and may include application servers, database servers, file servers, mail servers, print servers, web servers, or the like, or combinations thereof. The server device 12 may be implemented in a dedicated network or an open network like the World Wide Web or a cloud network. Furthermore, the server device 12 may include a plurality of physical servers, virtual servers, or combinations thereof. In some embodiments, the server device 12 may be physically separated or isolated from the participant devices 16. In other embodiments, the server device 12 may be included with, retained by, or executed on one or more of the participant devices 16. The server device 12 may be configured to include or execute software such as database applications, web server applications, file server applications, mail server applications, or the like.

The server device 12 may include a processing element 22 and a memory element 24, as shown in FIG. 2. The processing element 22 may include microprocessors, microcontrollers, digital signal processors (DSPs), field-programmable gate arrays (FPGAs), analog and/or digital application-specific integrated circuits (ASICs), and the like, or combinations thereof. The processing element 22 may generally execute, process, or run instructions, code, software, firmware, programs, applications, apps, services, daemons, or the like, or may step through states of a finite-state machine.

The memory element 24 may include data storage components such as read-only memory (ROM), programmable ROM, erasable programmable ROM, random-access memory (RAM), hard disks, floppy disks, optical disks, flash memory, thumb drives, universal serial bus (USB) drives, and the like, or combinations thereof. The memory element 24 may include, or may constitute, a “computer-readable medium”. The memory element 24 may store instructions, code, software, firmware, programs, applications, apps, services, daemons, or the like that are executed by the processing element 22. The memory element 24 may also store settings, data, user profiles, geographic coordinates, maps, routes, documents, sound files, photographs, movies, images, databases, and the like. The processing element 22 may be in communication with the memory element 24 through address busses, data busses, control lines, and the like.

The server application 14 generally maintains the data related to the system 10. The server application 14 may be formed from instructions, code, software, firmware, programs, applications, apps, processes, services, daemons, or the like. In various embodiments, at least a portion of the server application 14 may be implemented as a web site or web application which provides access to or viewing of maps, routes, and associated user profiles. In other embodiments of the invention, at least a portion of the server application 14 may be implemented as a mobile app on a smart phone, tablet, or other mobile computing device. Furthermore, the server application 14 may include data communications applications such as social networking, electronic mail, messaging such as the short message service (SMS), and the like.

The participant devices 16, as illustrated in FIGS. 3 and 4, generally allow users to manage their personal profiles and provide their current geographic location to the server application 14. Specifically, the participant devices 16 may allow the participants to communicate with the server device 12. The participant devices 16 may include electronic devices capable of executing an application and communicating through the communication network 20. Examples of the participant device 16, as shown in FIG. 3, include workstation computers, desktop computers, laptop computers, palmtop computers, notebook computers, tablets or tablet computers, smartphones, mobile phones, cellular phones, personal digital assistants (PDAs), and the like. The participant devices 16 may also include file servers, application servers, database servers, and the like. Typically, each participant device 16 includes a processing element 36 and a memory element 38, as seen in FIG. 4. The processing element 36 may be substantially the same as the processing element 22 in structure and function. The memory element 38 may be substantially the same as the memory element 24 in structure and function.

Each participant device 16 may also include a communication element 30 that permits the participant device 16 to communicate with the server device 12, the communication network 20, or other participant devices 16. The communication element 30 may communicate wirelessly and/or through wires. Wireless communication may utilize radio frequency (RF) communication including cellular or mobile phone standards such as 3G or 4G, Institute of Electrical and Electronics Engineers (IEEE) 802.11 standards for wireless networking, Bluetooth™ standards, and the like. Accordingly, the participant device 16 may include one or more broadband wireless transmitters and receivers. Wired communications may be implemented through metal conductor cables, wires, and connectors or optical fiber cables. Thus, each participant device 16 may include one or more transmitter and receiver circuits for use with cables.

The participant devices 16 may further include or be in communication with a geolocation device 32 that determines the geographical position of the device. The geolocation device may be or include a satellite navigation receiver that works with a global navigation satellite system (GNSS) such as the global positioning system (GPS) primarily used in the United States, the GLONASS system primarily used in the Soviet Union, or the Galileo system primarily used in Europe. The geolocation device may include an antenna to assist in receiving the satellite signals. The antenna may be a patch antenna, a linear antenna, or any other type of antenna that can be used with location or navigation devices. The geolocation device may further include one or more processors, controllers, or other computing elements and memory so that it may calculate location and other geographic information.

In some embodiments of the invention, as illustrated in FIG. 4, the participant devices 16 may also include cameras 48 configured for capturing digital pictures, video, and the like. However, some or all of the participant devices 16 may omit the camera 48 without departing from the scope of the invention.

The participant devices 16 may also each include a display 46 to display information and graphics to a user thereof. In some embodiments of the invention, the display 46 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display 46 may be backlit via a backlight such that it may be viewed in the dark or other low-light environments. In some embodiments of the invention, the display 46 may not be integrated into the participant device 16 and may instead be connected externally using universal serial bus (USB), Ethernet, serial connections, and so forth. In some embodiments of the invention, the display 46 may be provided with a touch screen to receive input (e.g., data, commands, etc.) from a user. For example, a user may operate the participant device 16 by touching the touch screen and/or by performing gestures on the screen. In some embodiments, the touch screen may be a capacitive touch screen, a resistive touch screen, an infrared touch screen, combinations thereof, and the like.

The participant devices 16 may also each additionally include a user interface 44 communicably coupled with the processing element 36. The user interface 44 may be configured for operation by the user to make user selections for viewing and manipulating displayed maps and information provided via the applications 14,18, as later described herein. The user interface 44 may comprise one or more functionable inputs such as buttons, switches, scroll wheels, keyboards, touch screen associated with the display 46, voice recognition elements such as a microphone, pointing devices such as mice, touchpads, tracking balls, styluses, a camera such as a digital or film still or video camera, combinations thereof, etc. The user interface 44 may also include an optional speaker for providing audible instructions and feedback.

The participant applications 18 generally allow the participants to enter, update, or change information about themselves and/or their location. The participant applications 18 may also allow users to receive alerts or notices regarding information stored on the server device 12. The participant applications 18 may include software, programs, applications, or apps such as database management software, spreadsheet software, text editing software, and so forth that are operable to manipulate relational data, hierarchical data, linked data, tabular data, text data, and the like. The participant applications 18 may further include applications or programs that are operable to handle data communications such as social networking, electronic mail, messaging such as the short message service (SMS), and the like, as well as web browsers, web viewers, or Internet browsers that are operable to access web sites. For example, at least a portion of the participant applications 14 may be implemented as mobile apps on a smart phone, tablet, or other mobile computing device which provides access to or viewing of maps, routes, and associated user profiles. In some embodiments of the invention, the participant applications 18 may also be able to process geolocation or sensor data that is received from the geolocation devices or sensors.

In general, both the server device 12 and the participant devices 16 may comprise one or more computer programs stored in or on computer-readable medium residing on or accessible by the server device 12 and/or the participant devices 16. For example, the server application 14 and/or the participant applications 18 may comprise computer programs. The computer programs may comprise listings of executable instructions for implementing logical functions in the server device 12 and/or the participant devices 16 and can be embodied in any non-transitory computer-readable medium, such as the memory elements 24,38, for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The communication network 20, as illustrated in FIG. 1, generally allows communication between the participant devices 16 and the server device 12 as well as communication from one participant device 16 to another. The communication network 20 may include local area networks, metro area networks, wide area networks, cloud networks, the Internet, or the like, or combinations thereof. The communication network 20 may also include or connect to voice and data communication systems such as cellular networks and public ordinary telephone systems. The communication network 20 may be wired, wireless, or combinations thereof and may include components such as switches, routers, hubs, access points, and the like. The participant devices 16 may connect to the communication network 20 either through wires, such as electrical cables or fiber optic cables, or wirelessly through known RF standards as discussed above.

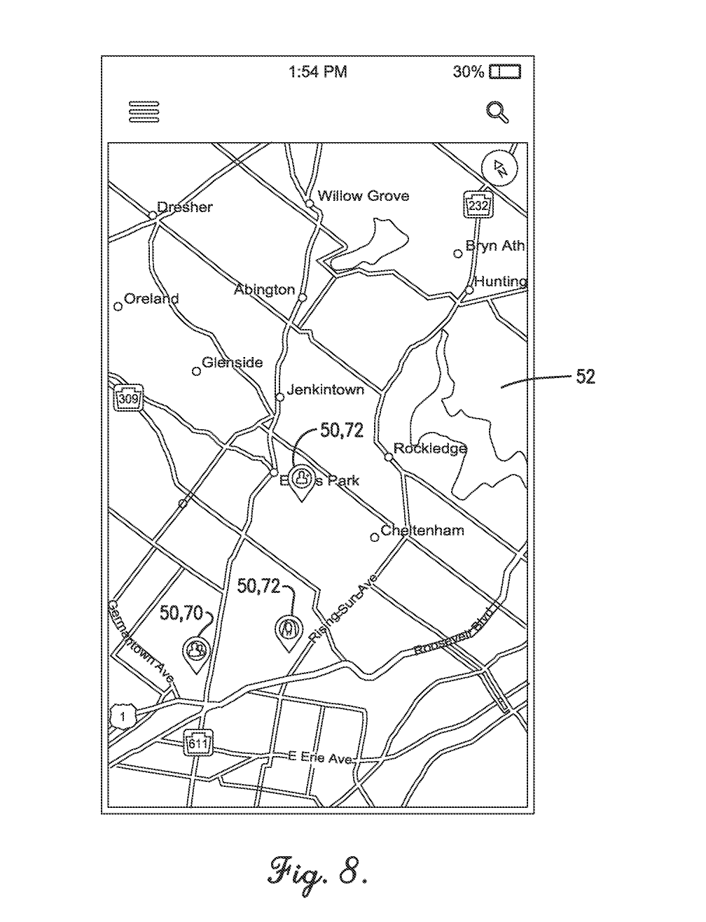

In operation, the server and/or participant applications 14,18 may associate participating users of the system 10 and their corresponding participant devices 16 with specific icons 50 on a map 52, as illustrated in FIGS. 8-10 and may associate these participating users with each other. Thus, participating users who are friends, belong to the same groups or circles, or are otherwise associated with each other, may be able to view geographic locations and movements of each other on the map 52 via the icons 50, and may also request certain interactions with each other directly through the map 52. For example, interactions which may be requested through interaction with the icons 50 on the map 52 may include selecting the icons 50 on the map 52 for turn-by-turn directions thereto, messaging participating users associated with selected ones of the icons 50, and/or to viewing user profiles of participating users associated with selected ones of the icons 50.

A method 100 for location-based social media interaction between a plurality of participating users, in accordance with various embodiments of the present invention, is shown in FIG. 5 and described in more detail below. The steps of the method 100 may be performed in the order as shown in FIG. 5, or they may be performed in a different order. Furthermore, some steps may be performed concurrently as opposed to sequentially. In addition, some steps may not be performed. Some of the steps may represent code segments or executable instructions of the computer program or applications described above.

The method 100, as illustrated in FIG. 5, may comprise the steps of receiving a plurality of user profiles 54 for a plurality of participating users, as depicted in block 102, and associating two or more participating users with each other as friends or part of a common group or circle, as depicted in block 104. Specifically, each participating user may register for an account via a web site or the participant application 18 on their respective participant devices 16 and may create their own user profile. After creating a user profile, the users may identify the other participating users they wish to communicate with or otherwise associate with. The information in the user profiles, as well as relationships established between participating users may be transmitted and stored in the server 12.

The method 100 may further comprise the steps of receiving geographic coordinates corresponding to geographic locations of the participant devices 16 of participating users, as depicted in block 106, and sending map information to participant devices 16 for displaying the icons 50 on the map 52 illustrating geographic locations of a plurality of the participating users associated with each other, as depicted in block 108. Specifically, the user profiles may each be associated or otherwise paired with the geolocation device 32 of the user's participant device 16, such that the user's location may be listed and/or graphically displayed to other participating users on the map 52 viewable by a plurality of the participating users via the displays 46 of their own participant devices 16. For example, the icons 50 depicted on the map 52 may represent locations of participating users. The system 10 may thus enable participating users to locate their friends and/or other participating users on the map 52. Map information for creating and/or updating the map 52 may be received by the participant devices 16 from the server 12 via the server application 14.

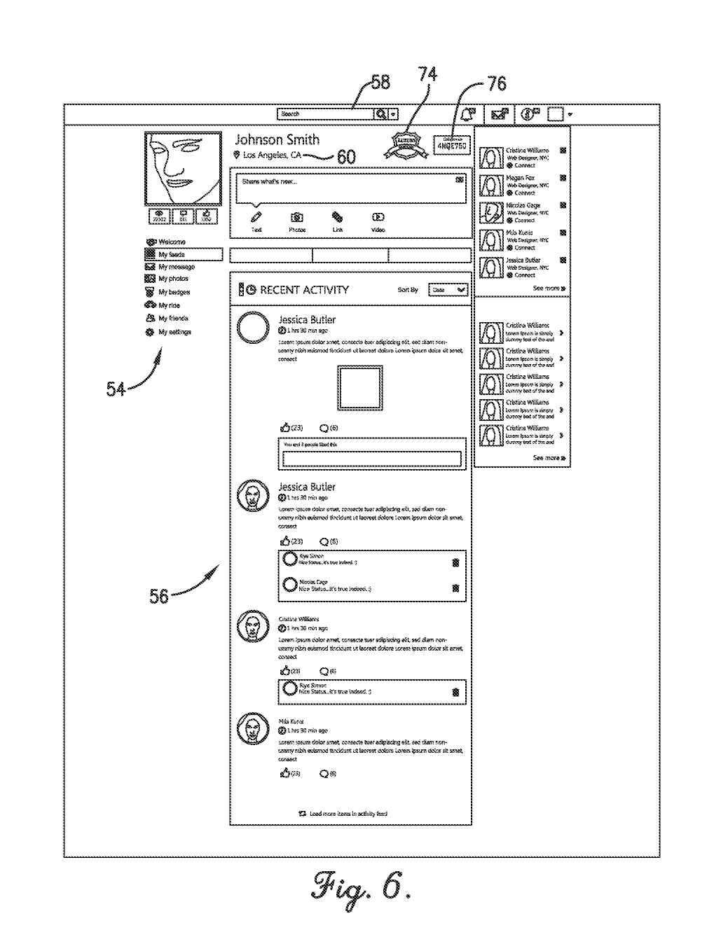

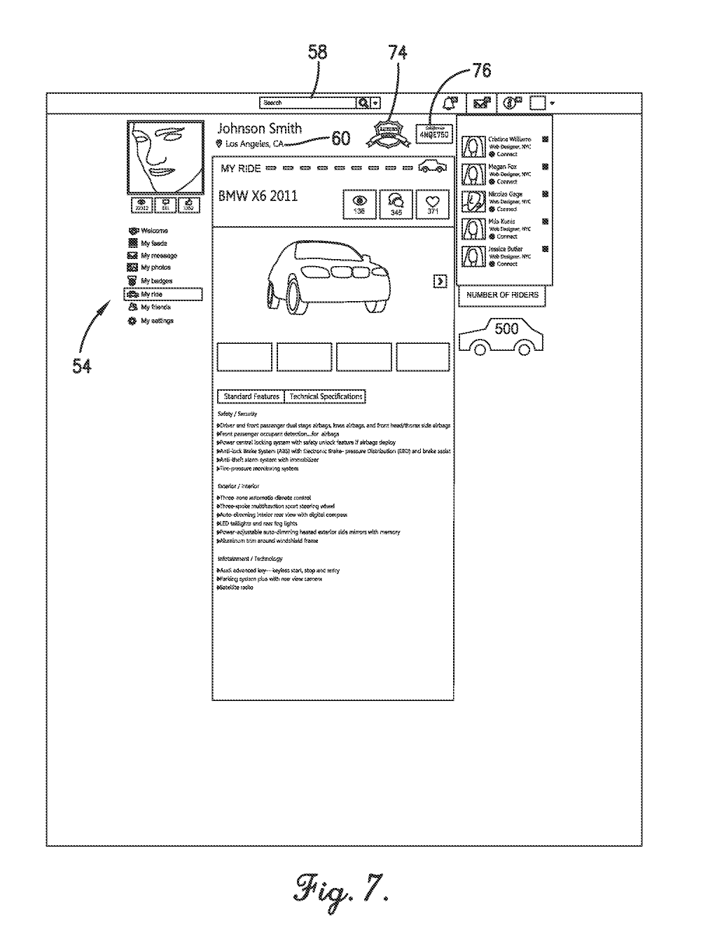

In addition to the map 52, other tabs 54 or selectable buttons or links, as illustrated in FIGS. 6 and 7, may be presented for selection by the participating user via the participant application 18 on the participant device 16. The tabs or selectable buttons or links may represent other pages, newsfeeds 56, discussion boards, messages, settings, badges, list of friends, user profiles, photo albums, vehicle details, videos, and the like. A search dialogue box 58 may be provided via the participant application 18, into which various search criteria may be entered in text form by participating users, as illustrated in FIGS. 6, 7, and 10. The search dialogue box 58 may allow for searching for other participating users and/or their user profiles, as well as locations viewable on the map 52 and any other searchable items in the server application 14 and/or the participant applications 18.

The user profiles may also include attributes or identifying characteristics such as a name, a description, a title, sex, age, birthday, other important dates or anniversaries, interests, one or more groups or circles to which the person or object belongs, levels of hierarchy (if applicable), a geographic location 60 (current or historical), route information associated with the current or historical geographic locations, license number, vehicle information, and the like. The user profiles may also include photographs, videos, graphics, and other displayable data uploaded or input by the user or by other participating users, depending on selected privacy settings. Items posted on the user profiles may be displayed on the newsfeed 56 displayed to friends of the posting participating user. Items displayed or updated on the user profile may also be configured to be liked, commented on in text form, and/or shared with other participating users, depending on selected privacy settings. Specifically, the user may select which information on his or her profile is viewable, able to be liked, able to be commented on, and/or able to be shared by which particular audience, participating user, or group of participating users. Counts regarding the number of times something is commented on, liked, or shared may be displayed with the corresponding item on the display 46. The user profiles may be edited by the users at any point or may change over time or as other events occur, such as when the participant device or participant travels to a new geographic location. Reminders for special dates or events associated with the user profiles may be provided to the corresponding participating user and/or some or all of their friends, depending on settings defined by the participating user.

Various terminologies may be used to identify relationships and actions taken between participating users of the computer program and/or applications 14,18 described herein. For example, the term “friends” may refer to participating users who mutually agreed to share, via the system 10, some information from their user profiles with each other, as well as certain current or past geographic location information. “Groups” or “circles” may refer to a relationship between any of the participating users and a specified group of other participating users. For example, a picture may be shared with a particular group or circle of participating users only, instead of being shared with all of the user's friends. The term “like” may be associated with selecting a graphical indication indicating approval or enjoyment of a post, status, or picture posted by other participating users. The term “post” or “status” may refer to text, pictures, video, or other communication sent to the server application 14 to be viewed by multiple other participating users or friends via their participant applications 18 on their participant devices 16. However, as noted above, a post or status may be presented to any audience, as selected by the participating user for each post or status. For example, a post or status may be presented to only one friend, to a specific group or circle of friends, or even made publically available for anyone to see.

Graphical indications of approval associated with a particular item posted by a participating user or associated with the participating users' user profiles may be selected by the participating users. For example, the term “like” or “liking” as used herein may refer to a user selecting a text or graphical indication that they are fond of or interested in something posed by or included in one of the participating users' user profiles. When a participating user “likes” a post, picture, or other item, a like counter may be increased, with a total number of “likes” displayed on or near the post, picture, or other associated item. Similar counters may be used to show the number of messages, number of comments, number of shares, and/or number of views a posted item has received. Furthermore, the term “tag” as used herein may refer to associating one of the participating users with a particular post. For example, tagging a friend in a picture, video, or post may create a link to that person's user profile selectable by those viewing the picture, video, or post. The term “tap” may be used herein to refer to a selection by a first one of the participating users which notifies a second one of the participating users that the first one of the participating users is interesting in learning more about them. This feature may be used in lieu of sending a blind friend request to a stranger.

The method 100 may further comprise the steps of receiving a selection of one of the icons 50 on the map 52 from a first one of the participant devices for navigation purposes, as depicted in block 110, and sending to the first one of the participant devices route directions for traveling from the first one of the participant devices to the second one of the participant devices or to a waypoint therebetween, as depicted in block 112. Specifically, navigation capabilities may be integrated into the server application 14 and/or the participant applications 18 to provide turn-by-turn directions to specific ones of the participating users, specific locations, addresses, or waypoints between participating users. This navigation may continue to be provided even if the target (selected participating user) is moving and not stationary. These navigation capabilities may be provided directly within the participant application 18 without linking to a secondary navigation application, such as GOOGLE MAPS. Alternatively, a third-party navigation application may be embedded into the participant application 18 and displayed therein on the participant device 16.

In addition to the icons 50 representing the participating users, geographic locations may be indicated on the map 52, such as restaurants, stores, schools, and the like. Furthermore, participating users may rate various geographic locations, and these ratings may be provided to other participating users via the map 52, as displayed on their participant devices 16. In some embodiments of the invention, the participating users may only rate geographic locations at which they have “checked in,” as described below.

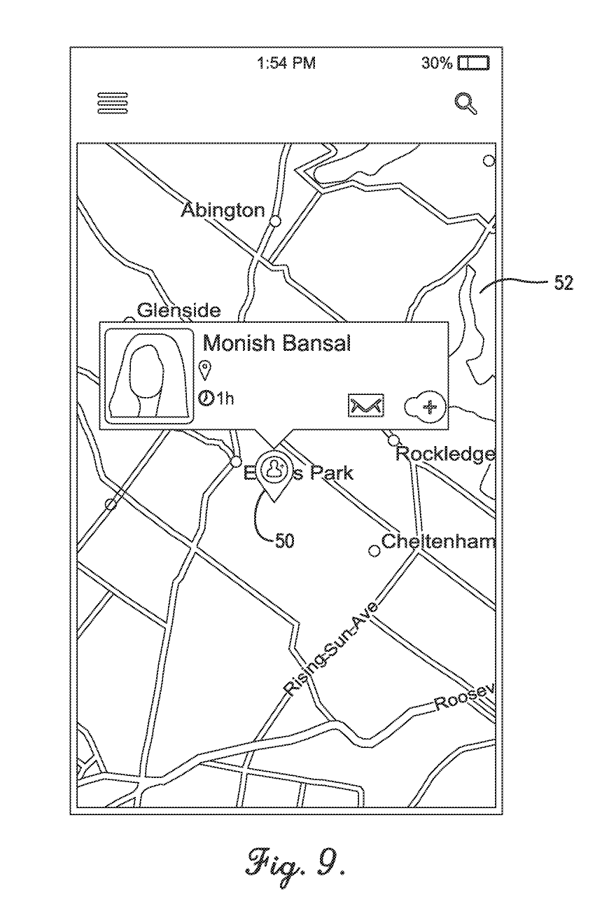

The participating users may view maps corresponding with their current location and/or with a selected address or destination on their participant device 16. The geographic area's size represented by the map 52 may also be selected by the participating user. The system 10 may use real-time geographic information about the participant devices 16 of the participating users to display various the icons 50 at corresponding locations within the map 52, via the server and/or participant applications 14,18. The icons 50 on the map 52 may be color coded or include a picture or symbol corresponding to its associated participating user. When scrolled over or otherwise selected, as illustrated in FIG. 9, further details may be provided regarding the participating user associated with the icon 50, including name, time past since location last updated, time spent at a particular location so far, picture, links to add as a friend or to a group or circle, links to message the participating user associated with the icon 50, and the like.

In some embodiments of the invention, the icons 50 may also include an associated address location which can be used to create turn-by-turn directions to or from the participating user. For example, when one of the icons 50 is selected by the participating user of the participant device 16, a distance between that user and that selected participating user may be displayed on the display 46 of the participant device 16 along with an approximate time to reach this selected participating user via a selected or assumed mode of transportation (i.e., by car, by foot, etc.).

The method 100 may also include the step of determining a location of the waypoint between the first and second participant devices, as depicted in block 114. In some embodiments of the invention, this step may occur prior to step 112 described above. However, in other embodiments of the invention, route directions for traveling from the first one of the participant devices to the second one of the participant devices may be sent to a user first, and then the user may select the option to determine a waypoint instead. Waypoints between two users may be selected based on a variety of criteria selected by one or more participating users. For example, the server and/or participant applications 14,18 may provide two participating users with directions via the participant applications 18 on their respective participant devices 16 to a restaurant closest to a midway point on a navigation route between the two participating users. Alternatively, selecting waypoints between two or more participating users may include selecting an exact middle point distance-wise or time-wise along a route. Other criteria may include a commercial, office, or residential address, landmarks, types of vehicles permitted, what amenities are available at specific locations, and the like.

In some embodiments of the invention, navigation routes may be provided to multiple destinations and/or to the location of multiple users. For example, participating users may schedule out a full trip with multiple stops and locations and identify an optimal route. The participating users may use generic store names for companies with multiple locations. The server and/or participant applications 14,18 may identify locations that are along the route of other tasks to be performed or that are most favorable based on the other tasks to be performed.

Participating users may track and share their fitness patterns with others via their user profiles. Additionally or alternatively, participating users may choose to have such fitness information displayed on the map 52 along with their icon 50 indicating the participating user's current or last-logged location. The server and/or participant applications 14,18 may access and/or create running routes and track distances ran, then calculate and present statistical data to the participating user and/or the participating user's friends.

In another embodiment of the invention, a carpooling feature may be included in the server and/or participant applications 14,18 which provides routes for picking up multiple participating users and traveling to a particular destination based on selected criteria such as the shortest distance, the shortest amount of travel time, and the like. In some embodiments of the invention, participating users desiring to carpool with other participating users may have their associated icons 50 on the map 52 displayed on the participant devices 16 shown as a different color and/or symbol indicating a carpool request or the starting of a carpool group or route.

The map 52 or maps displayed on the participant devices 16 may also be used to view and update hazards, speed traps, road work, road-side parking options, or other information that a driving community at large may find helpful. For example, one of the participating users may select an “automobile accident” icon from a menu of options and place it at a desired geographic location and/or provide an intersection at which the automobile accident occurred. Additionally, participating users that have travelled to certain locations may use the map 52 to indicate parking at specific locations and share their parked location with others.

In some embodiments of the invention, the method 100 may include the steps of receiving a request for roadside assistance from a participant device, as depicted in block 116, and contacting a roadside assistance vendor and providing the roadside assistance vendor with a geographic location of the participant device, as depicted in block 118. For example, the participating users may contact roadside assistance in event of a roadside emergency by selecting such options in the participant application 18 of their respective participant devices 16. The participant application 18 may then contact a roadside assistance provider and indicate a type of emergency that has occurred (e.g., “out of gas,” “flat tire,” “car accident,” Broken down,” etc.). Using the geolocation device 32 of the participant device 16, an exact location of the participating user requesting roadside assistance may be broadcast to the roadside assistance provider.

The method 100 may further comprise the steps of receiving a selection from a participant device of one of the icons 50 on the map 52 for friending, as depicted in block 120, and sending a friend request to a participating user corresponding to the selected one of the icons 50, as depicted in block 122. Friends of the user included in selected groups or circles may be denoted by different colored icons or icons of a different design or shape. The groups or circles of friends may be created and organized directly from the map 52 by selecting the icons 50 displayed on the map 52 via the participant devices 16. For example, a tool for adding friends to a particular group or circle may be selected, and then specific icons on the map 52 may be selected to place a friend in a particular circle or group. Alternatively, the icons 50 on the map 52 may be selected and dragged into an area on the display 46 denoted in the participant application 18 as being associated with a particular circle or group. This feature may be useful if these participating users' full names, license plate numbers, or other necessary search data for adding a friend is unknown to the requesting participating user. For example, if a participating user wants to send a group or circle invite or request to all participating users taking a yoga class at a particular studio at a given time, this request may be made by selecting all participating users' icons 50 shown at the geographic location of the yoga studio at that particular time.

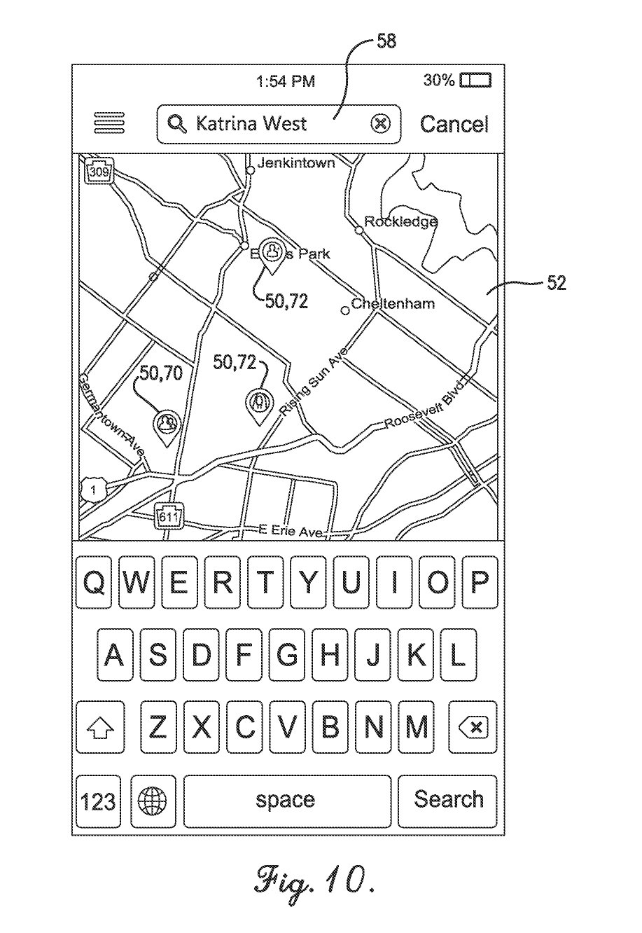

In some embodiments of the invention, the icons 50 associated with participating users in a similar location may be clustered together and represented by a single icon 70 for easier viewing, depending on the map 52 resolution or level of zoom, instead of being displayed as individual friend icons 72, as depicted in FIG. 10. For example, zooming in to a location on the map 52 may cause a cluster of friends shown as the single icon 70 to separate into the individual friend icons 72, while zooming out may place the individual friend icons 72 into the single icon 70 representing a cluster of friends.

The participating users' last activity time and location may be tracked by the server application 14 using the geolocation device 32 and displayed on the map 52 to other participating users or the participating users' friends. For example, if the participant application 18 is no longer running on a particular participating user's participant device 16, the icon 50 associated with that participating user may be shown on the map 52 at that user's last physical location, along with the time of this user's last activity, as received and recorded by the server application 14.

The participating user's last physical location may be based on participating users “checking-in” to a location or event via the server and/or participant applications 14,18 described herein. The term “check-in” as used herein refers to posting or otherwise indicating a location and associated time to other participating users. For example, although a participating user's current location may be indicated on the map 52, past or historical geographic locations may in some instances only be available to the participating user's friends (such as displayed on a home page or user profile) when the participating user has checked in at a particular location.

The method 100 may comprise a step of sending a command to sound an audible alarm on the participant device 16 when selected ones of the participating users are within a predetermined geographic distance from the participant device 16, as depicted in block 124. Specifically, when one participating user is near in proximity to another participating member, the server and/or participant applications 14,18 may provide a visual, tactile, or audible notification or “honk” via the participant devices 16 associated with these participating users. For example, when the user is within a 1-mile radius of a geographic location of another participating user and/or a select one of the participating users, an audible tone may be triggered. In some cases, this notification may serve as a warning in case interaction with a particular participating user is undesired. For example, these notifications may be customized for each participating user that is flagged for warning notification.

The method 100 may further include the steps of receiving a selection of one or more of the icons 50 on the map 52 for messaging purposes, as depicted in block 126, and sending messages to the participating devices 16 corresponding to the selected icons 50, as depicted in block 128. Specifically, in some embodiments of the invention, messages, posts, or other updates by the user may be broadcast to participating users only in a specific geographic location, a specific geographic area, or a selected geographic range from the user outputting the broadcast. Additionally or alternatively, the user may broadcast messages, posts, or updates to selected clusters of participating users whose corresponding icon 50 was selected directly on the map 52. Broadcasted messages may appear under a menu option (e.g., “My Messages”) displayed via the participant application 18 on the participant device 16. Additionally or alternatively, some messages may be displayed on the participating users' digital walls, newsfeeds, profile pages, boards, or the like and may be viewable publically, to a select audience, or only to the participating user to which the message was broadcast. Messages may also include text messages and/or instant messaging interfaces presented within the participating application 18 on the participant device 16. In some embodiments of the invention, certain messages may self-delete after reading or upon a set expiration date. For example, these self-deleting messages may be called “Shh messages” and may be confidential message intended certain participating users to see, but to be kept private from other individuals.

The method 100 may also comprise the steps of receiving a geographic boundary for a privacy bubble from one of the participant devices 16, as depicted in block 130, and hiding, on the map 52, icons 50 associated with one of the participant devices when it is within the geographic boundary for the privacy bubble, as depicted in block 132. Specifically, participating users may designate a geographic location or a specific geographic area as a “privacy bubble.” Within this privacy bubble, the participating user's icon 50 will not be presented on the map 52 to other participating users, despite the participant application 18 running on the user's participant device 16. This feature may provide a safe zone in which the user's movements are not being monitored by other participating users. In some embodiments of the invention, some participating users may clone their location to another location on the map 52 displayed to other participating users. The associated cloned icon may remain in place on the map 52, even while the associated participant device 16 moves to a new location. This feature may be available to all participating users or alternatively only to those purchasing or otherwise achieving a certain level of membership within the system 10 and the server application 14.

Participating users may elect to receive, via the server and/or participant applications 14,18, notification messages, emails, or push notifications indicating messages received, new friend requests, accepted or declined friend requests, comments posted in response to route activity, or likes received on route activity postings. The participating user may also provide messages and requests to other users, such as friend requests, meet-up requests, or requests to tag other participating users in an event, video, photo, post, status, or the like. For example, if one user is interested in learning more about another participating user, a “tap notification” may be sent in lieu of a blind friend request. Performing this tap on another participating user may allow for additional chances to meet and interact with new people without necessarily friending them.

The method 100 may comprise the steps of receiving vouching notifications, referencing one of the participating users, from multiple participating users, as depicted in block 134, and adding a confirmation marking to the user profile or icon 50 associated with the referenced one of the participating users when a predetermined number of vouching notifications associated therewith are received, as depicted in block 136. Specifically, participating users may receive a special mark or other indicia on their profiles indicating or confirming that the participating user and associated postings belong to an actual person and are truthful. For example, the participating user may be required to receive a particular number of other participating users vouching for them and confirming that the data presented in their user profile is accurate in order to receive a confirmation marking on their user profile and/or on their icon 50 displayed on the map 52. The confirmation marking may include a symbol, an icon, text, a particular color, or any visual indication that a participating user has been verified as authentic. In some embodiments of the invention, this vouching may require a certain number of participating users both in and out of specific friendship circles. For example, a first “vouching” symbol may indicate that a pre-determined number of participating users have vouched for the participating user, while a second “vouching” symbol may indicate that a pre-determined number of participating users within a specific friend circle have vouched for the participating user. In some embodiments of the invention, a certain number of or percentage of participating users within a specific friend circle may be required to vouch for a participating user before the participating user is allowed within the friend circle. These and other various checks may be incorporated into the server and/or participant applications 14,18 to assist in determining the legitimacy of any of the participating users.

Participating users may block incoming messages and friend requests from other individuals for any reason. Block settings can be customized and configured per participating user. Furthermore, participating users may be allowed to report behavior that conflicts with any terms and conditions of the system 10 and associated applications 14,18 directly to administrators thereof via menu options in the participant application 18. This reporting done directly through the participant application 18 may be tracked behind the scenes via the server application 14. Participating users for which multiple complaints are received may be investigated by the administrators of the system 10 and associated applications 14,18. Any threshold number of complaints for triggering such an investigation may be pre-programmed into the server application 14, stored in the associated databases described herein, and/or selected by the administrators without departing from the scope of the invention.

The participating users may customize their user profiles via menu options displayed on and selected via the participant devices 16. Some customization options may be specifically available for certain membership levels only. For example, some membership levels may customize a layout and color palates of pages or tabs with pre-selected themes, while other membership levels may not. Each theme may have a custom layout and color selection. As noted above, various membership levels may be purchased or otherwise achieved in a variety of ways, as further described below. A participating user's membership level may be displayed as a symbol 74 on their user profile pages, for example, as illustrated in FIGS. 6 and 7.

In some embodiments of the invention, the method 100 may comprise the steps of receiving a selection from one of the participant devices 16 indicating interest in an activity never done or a location never visited, as depicted in block 138, and sending advertising associated with or special offers for the activity never done or the location never visited to the corresponding participant device 16, as depicted in block 140. Specifically, a button or menu option may be provided along with particular activity postings, pictures, or the like which, when selected, indicates that a fellow participating user has never conducted that particular activity pictured or posted above. For example, the button or menu option may be identified as “I never did that” or “I never . . . ” By selecting this button or menu option, the participating user may indicate that they are interested in exploring that activity in the future. For example, information from this type of feedback may be tracked via the server application 14 and used to provide custom offers to participating users who have never conducted a particular task or activity, but may want to explore that option at a discounted price in the future.

The user profiles may also be customized to include information about the participating user's vehicle, such as year, make, model, license plate number and state, color, features, specs, if the vehicle is for sale, an asking price for the vehicle, and the like. For example, as illustrated in FIG. 7, the user's vehicle information may be displayed under a selectable user profile tab or heading labeled “My Ride.” Furthermore, the participating user's license plate number may be displayed as a graphic 76 on one or more user profile pages and/or on the map 52 for other participating users to view. The vehicle information may also include various pictures of the vehicle or other digital media related to the user's vehicle, as well as information about what modifications have been completed on the vehicle. Some groups, circles, or forums available via the participant applications 18 may be associated with interest in particular vehicles, associated with those wishing to sell or purchase vehicles, or associated with those seeking help regarding particular vehicles.

The method 100 may further comprise the steps of receiving vehicle information to search, as depicted in block 142, determining if any user profiles contain information corresponding to the vehicle information, as depicted in block 144, and sending information from one or more of the user profiles having the vehicle information therein back to the participant device 16 from which the vehicle information was received, as depicted in block 146. The vehicle information may include any of the vehicle information described above, such as a type of car or specific license plate information. In some embodiments of the invention, the participating users may search for other users that own the same vehicles and contests may be planned via the server application 14 specific to the participating users' vehicles on file and accessible thereby. Search results may be displayed directly on the map 52. For example, the map 52 displayed on the participant devices 16 may filter which ones of the icons 50 are displayed thereon based on the participating user's name, a specific car type, make, or model, a license plate number and/or associated state, and the like. In some embodiments of the invention, the method 100 may also include a step of sending a message to the participant devices 16 associated with user profiles containing information corresponding to the vehicle information, as depicted in block 148. For example, custom messages may be sent to specific participating users through the use of their license plate numbers. Participating users that do not have the name or other identifying information for another participating user may enter the license plate number and create a custom message to send to any other participating user. The “license plate number” as used herein, may comprise letter, numbers, or a combination of letters and numbers without departing from the scope of the invention.

In some embodiments of the invention, participating users may be required to enter their license plate numbers during the registration process, particularly if they wish to obtain certain membership levels. For example, to prevent fraudulent profiles, the license plate number may be verified during registration to confirm the identity of the participating user. However, in some embodiments of the invention, a license plate number may not be required for all participating users or all membership levels.

In some embodiments of the invention, the camera 48 may be used to take pictures of a license plate and send a private message to the owner of the vehicle. Specifically, code segments of the server or participant applications 14,18 described above may be configured for reading the license plate state and number from the picture and initiating messaging from within the server application 14 and/or the participant application 18. For example, the applications described herein may be configured for determining at least one of a state associated with the license plate and a license plate number on the license plate. The participating user may create a custom message to be sent to the owner of the license plate in the picture and the message may be forwarded to the owner of the license plate if they are one of the participating users.

The system 20 and/or associated computer programs described herein may provide a reward system associated with locations visited, total miles traveled, miles associated specific events or types of activities, and the like while running the participant application 18. However, reward points or reward miles may be rewarded for any activity within the participant application 18 without departing from the scope of the invention. Participating users may redeem their reward miles for digital and/or tangible goods. Specifically, physical and digital gifts may be available via the system 10 and server and/or participant applications 14,18 described herein. For example, digital or physical gifts may be purchased with reward miles, and/or using a transaction fee. Participating users may send these gifts to any other participating user.

Reward miles may additionally or alternatively be applied to award participating users with accomplishment badges for actions completed. The accomplishment badges may be displayed as part of the participating user's profile and/or icon 50 on the map 52. In some embodiments of the invention, higher membership levels may be achieved based on reward miles obtained. As described herein, various membership levels allow different levels of access, different features, and different capabilities.

The server and/or participant applications 14,18 may also be configured to facilitate the purchasing, sending, and/or gifting of digital media such as songs, movies, videos, or other digital media through various digital vendors, such as the APPLE app store, GOOGLE PLAY, or other designated digital media marketplaces. Purchased media may be forwarded to a recipient who may receive and retain digital rights to the media purchased. The purchase price of the media may be charged to the participating user that initiates the transaction. In some embodiments of the invention, participating users may listen to playlists of another user from their circles. Friends that have playlists available to listen to may be signified by a special icon, symbol, or other visual indicia.

The server and/or participant applications 14,18 may also incorporate college campus-specific icons or colors into the map 52 for easy reference and the ability to visually search the map 52 for a particular college campus. Participating users may use this feature to locate a college location and, using a zoom feature of the map 52, may be able to identify other participating users that are in close proximity or directly on the college campus.

Contests for participating users, college campuses, and/or vehicles may be managed and conducted via the server and/or participant applications 14,18. For example, contest information may be released to participating users prior to a start of the contest and may be unique for each contest period. Prizes for the contest winners may be identified prior to the start of the contest period and may be shipped to or digitally delivered to contest winners at completion of the contest period. Some contests, for example, may be based on reward miles, as described above, and/or specific locations visited or specific events attended by the participating users. Other contests may be based strictly on chance or luck, with winners selected at random. Some contests may be limited to participating users located within a particular geographic location and/or at a specific location at a specific time (such as at a restaurant at a specific time of day).

Matchmaking between participating users may be facilitated via the server and/or participant applications 14,18 by sending matchmaking messages to two friends of a participating user indicating that someone believes these two friends would be a good match and should meet with one another. Although the two friends to be matched may both be friends with the participating user attempting to match them together, but may not necessarily be friends with each other at the time the matchmaking message is sent to them. Furthermore, the server and/or participant applications 14,18 may be configured to suggest matches to participating users based on similar interests, hobbies, activities, and the like. These matches may not necessarily be suggested romantic matches, but may merely match participating users with similar interests.

In some embodiments of the invention, the method 100 may further comprise the steps of receiving a request for automated check-up calls, as depicted in block 150, and calling the associated participant device 16 at predetermined intervals to verify safety and security, as depicted in block 152. Specifically, if any participating user wishes to meet with one or more participating users, perhaps blindly or for the first time, the server and/or participant applications 14,18 may include these security features to remove the risk of interacting with a stranger. For example, the security features may allow the participating users to set up automated check-up calls via the server or participant applications 14,18 to verify that the participating user is safe and secure. The security call may be made using an automated message and may provide the participating user with an option of rescheduling a callback for a later time, disabling the callback feature, or calling an emergency contact or emergency line. Unanswered calls may be automatically rescheduled at predetermined intervals, such as 5 minutes, and may result in calls to emergency contacts after a set number of calls go unanswered.

Another security feature incorporated into the applications 14,18 described herein may allow participating users to flag any suspicious activity in their neighborhoods with a special icon on the map 52. Once the action is flagged, a push notification may be sent to all participating users that are within the vicinity of the activity.

In some embodiments of the invention, the method 100 may include the step of sending targeted advertisements to the participant devices 16 based on routes traveled or routes currently being traveled thereby, as depicted in block 154. Specifically, targeted advertisements may be presented to participating users anywhere within the participant application 18 based on participating users' routes traveled, likes, interests, and/or hobbies. For example, these advertisements may be for products available along a participating user's routine routes or located nearby the participating user's current location. In some embodiments of the invention, participating users may opt out of receiving advertising or special offers. Furthermore, participating users seeking to increase the size of their social network may pay a nominal fee to have their information pushed out to all participating users via the server application 14.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for location-based social media interaction between a plurality of participants, the system comprising:
a server device including a processing element and associated memory element, the processing element configured to execute a server application stored in the memory element, the server application including:
a code segment for receiving a plurality of user profiles for a plurality of participating users;
a code segment for associating two or more of the participating users with each other, such that participant devices of the participating users associated with each other may access at least some information from each other's user profiles;
a code segment for receiving geographic coordinates corresponding to geographic locations of the participating users from geolocation devices of the participant devices of the participating users; and
a code segment for sending map information to at least some of the participant devices, wherein the map information is configured to display icons on a map on the participant devices illustrating geographic locations of a plurality of the participating users.

2. The system of claim 1, further comprising:
a code segment for receiving a selection of one of the icons on the map from a first one of the participant devices of a first one of the participating users, wherein the selected one of the icons corresponds with a second one of the participating users having a second one of the participant devices; and
a code segment for sending to the first one of the participant devices route directions for traveling from the first one of the participant devices to the second one of the participant devices or to a waypoint between the first one of the participant devices and the second one of the participant devices.

3. The system of claim 2, further comprising:
a code segment for determining a location of the waypoint between the first and second participant devices, wherein the location is: equidistance between the first and second participant devices, a point along the route directions between the first and second participant devices that provides equal traveling time for the first and second participating users, or at a type of geographic location selected by the first or second participating users at a point closest to a mid-way point along the route directions between the first and second participant devices.

4. The system of claim 1, further comprising:
a code segment for receiving vehicle information from a requesting one of the participant devices;
a code segment for determining if any of the user profiles contain information corresponding to the vehicle information; and
a code segment for sending information from one or more of the user profiles corresponding to the vehicle information back to the requesting one of the participant devices, or a code segment for sending a message to at least one of the participating users' participant devices associated with the user profiles containing information corresponding to the vehicle information.

5. The system of claim 1, further comprising:
a code segment for receiving license plate information from a requesting one of the participant devices;
a code segment for determining if any of the user profiles contain information corresponding to the license plate information; and
a code segment for sending information from one or more of the user profiles corresponding to the license plate information back to the requesting one of the participant devices, or a code segment for sending a message to at least one of the participating users' participant devices associated with the user profiles containing information corresponding to the license plate information.

6. The system of claim 5, wherein the license plate information comprises a picture of a license plate, wherein the code segment for determining if any of the user profiles contain information corresponding to the license plate information may further comprise a code segment for determining at least one of a state associated with the license plate and a license plate number on the license plate, wherein the license plate number may comprise letter, numbers, or a combination of letters and numbers.

7. The system of claim 1, further comprising:
a code segment for receiving a selection of one of the icons on the map from a requesting one of the participant devices, wherein the selected one of the icons corresponds with a targeted one of the participant devices; and
a code segment for sending to the targeted one of the participant devices a message from the requesting one of the participating devices.

8. The system of claim 1, further comprising:
a code segment for receiving a selection of a plurality of the icons on the map from a requesting one of the participant devices, wherein the selected plurality of the icons corresponds with targeted ones of the participant devices; and
a code segment for sending to the targeted ones of the participant devices a message from the requesting one of the participating devices.

9. The system of claim 1, further comprising:
a code segment for receiving a selection of one of the icons on the map from a requesting one of the participant devices associated with a requesting one of the participating users, wherein the selection indicates that the requesting one of the participating users desires to be associated with a one of the participating users corresponding to the selected one of the icons; and
a code segment for sending a request to the one of the participating users corresponding to the selected one of the icons to approve association with the requesting one of the participating users.

10. The system of claim 1, further comprising:
a code segment for receiving a request for automated check-up calls from a requesting one of the participant devices associated with a requesting one of the participating users; and
a code segment for calling the requesting one of the participant devices at predetermined intervals to verify that the requesting one of the participating users is safe or secure.

11. The system of claim 1, further comprising:
a code segment for receiving, from a plurality of participant devices, vouching notifications referencing one of the participating users; and
a code segment for adding a confirmation marking to one of the user profiles or one of the icons associated with the referenced one of the participating users when a predetermined number of vouching notifications for the referenced one of the participating users is received, wherein the confirmation marking visually indicates verified authenticity of the referenced one of the participating users.

12. The system of claim 1, further comprising:
a code segment for receiving a request for roadside assistance from a requesting one of the participant devices; and
a code segment for contacting a roadside assistance vendor and providing the roadside assistance vendor with a geographic location of the requesting one of the participant devices.

13. The system of claim 1, further comprising:
a code segment for sending targeted advertisements to at least some of the participant devices based on routes traveled or being traveled by the participating users associated with the participant devices.

14. The system of claim 1, further comprising:
a code segment for receiving a selection from a requesting one of the participant devices associated with a requesting one of the participating users, wherein the selection indicates interest in an activity never done or a location never visited; and
a code segment for sending advertising associated with or special offers for the activity never done or the location never visited to the requesting one of the participant devices.

15. The system of claim 1, further comprising:
a code segment for receiving a geographic boundary for a privacy bubble from a requesting one of the participant devices associated with a requesting one of the participating users; and
a code segment for hiding a one of the icons associated with the requesting one of the participant devices when the requesting one of the participating users is within the geographic boundary for the privacy bubble, wherein the hiding includes preventing display of the icon on other ones of the participant devices.

16. The system of claim 1, further comprising:
a code segment for sending a command to a requesting one of the participant devices to sound an audible alarm when one or more selected ones of the participating users are within a predetermined geographic distance from the requesting one of the participant devices.

17. The system of claim 1, further comprising:
a code segment for receiving a cloning request from a requesting one of the participant devices associated with a requesting one of the participating users and associated with a cloned one of the icons on the map;
a code segment for freezing a location of the cloned one of the icons on the map while a location of the participant device changes to a new location.

18. A non-transitory computer-readable storage medium with an executable program stored thereon for location-based social media interaction between a plurality of participants, wherein the program comprises:
a code segment for receiving a plurality of user profiles for a plurality of participating users;
a code segment for associating two or more of the participating users with each other, such that participant devices of the participating users associated with each other may access at least some information from each other's user profiles;
a code segment for receiving geographic coordinates corresponding to geographic locations of the participating users from geolocation devices of the participant devices of the participating users;
a code segment for sending map information to at least some of the participant devices, wherein the map information is configured to display icons on a map on the participant devices illustrating geographic locations of a plurality of the participating users; and
a code segment for receiving a selection of one of the icons on the map from a first one of the participant devices of a first one of the participating users, wherein the selected one of the icons corresponds with a second one of the participating users having a second one of the participant devices; and
a code segment for sending to the first one of the participant devices route directions for traveling from the first one of the participant devices to the second one of the participant devices or to a waypoint between the first one of the participant devices and the second one of the participant devices.

19. The non-transitory computer-readable storage medium of claim 18, further comprising:
a code segment for receiving license plate information from a requesting one of the participant devices;
a code segment for determining if any of the user profiles contain information corresponding to the license plate information; and
a code segment for sending information from one or more of the user profiles corresponding to the license plate information back to the requesting one of the participant devices, or a code segment for sending a message to at least one of the participating users' participant devices associated with the user profiles containing information corresponding to the license plate information.

20. A computer-implemented method for location-based social media interaction, the method comprising the steps of:
receiving, with a server, a plurality of user profiles for a plurality of participating users;
associating, with the server, two or more of the participating users with each other, such that participant devices of the participating users associated with each other may access at least some information from each other's user profiles;
receiving, with the server, geographic coordinates corresponding to geographic locations of the participating users from geolocation devices of the participant devices of the participating users;
sending, with the server, map information to at least some of the participant devices, wherein the map information is configured to display icons on a map on the participant devices illustrating geographic locations of a plurality of the participating users; and
receiving, with the server, a selection of one of the icons on the map from a first one of the participant devices of a first one of the participating users, wherein the selected one of the icons corresponds with a second one of the participating users having a second one of the participant devices;
determining, automatically with the server, a location of a waypoint between the first participant device and the second participant device, wherein the location of the waypoint is: equidistance between the first and second participant devices, a point along a route for traveling between the first and second participant devices that provides equal traveling time for the first and second participating users, or at a type of geographic location selected by the first or second participating users and closest to a mid-way point along the route between the first and second participant devices; and
sending, with the server, to the first one of the participant devices, turn-by-turn directions for the route for traveling between the first and second participant devices or turn-by-turn directions to the waypoint.
